(19) United States
(12) Patent Application Publication
(10) Pub. No.: US 2021/0048350 A1
(43) Pub. Date: Feb. 18, 2021

(54) APPARATUS AND METHOD FOR MEASURING A TEMPERATURE DISTRIBUTION ON A SURFACE

(71) Applicant: LEONI KABEL GMBH, Roth (DE)

(72) Inventor: Thomas Damerow, Pleinfeld (DE)

(21) Appl. No.: 16/966,928

(22) PCT Filed: Feb. 4, 2019
(86) PCT No.: PCT/EP2019/052575

§ 371 Date: Aug. 3, 2020

(30) Foreign Application Priority Data
Feb. 5, 2018 (DE) 10 2018 102 471.1

(51) Int. Cl. G01K 7/16; G01K 1/14; G01K 3/06

(52) U.S. Cl. CPC G01K 7/16; G01K 3/06; G01K 1/143

(57) ABSTRACT

An apparatus for measuring a temperature distribution on a surface has a first plurality of conductors, which are each arranged parallel in relation to one another, and a second plurality of conductors, which are each arranged parallel in relation to one another. The apparatus further has a connection conductor, which is electrically conductively connected to a voltage source, and an evaluation unit. Each conductor of the first plurality of conductors crosses each conductor of the second plurality of conductors and each conductor of the first plurality of conductors is electrically isolated from each conductor of the second plurality of conductors. A first conductor end of the conductors, both of the first plurality of conductors and also of the second plurality of conductors, is in each case electrically conductively connected to the connection conductor, and a second conductor end of the conductors, both of the first plurality of conductors and also of the second plurality of conductors, is in each case connected to a voltage measuring apparatus which is arranged and designed to determine a voltage drop across the individual conductors in each case. The evaluation unit is designed to ascertain a temperature distribution on the basis of the determined voltage drops across the individual conductors.

The invention relates to an apparatus and a method for measuring a temperature distribution on a surface.

In many technical applications, it is necessary to determine a temperature profile, or the local distribution of a warming of an extensive area. For example, in order to determine energy efficiency values or to test technical components provided for thermal insulation for heat or cold bridges, it may be necessary to determine a locally resolved temperature distribution of the technical components under use conditions.

In known apparatuses, a large number of individual temperature sensors must for this purpose be arranged at/on the surface of the component. The higher the required or intended resolution of the local temperature determination, the larger the number of temperature sensors required therefor. In addition, each of the required temperature sensors must be electrically connected to at least two measuring lines, so that the number of measuring lines corresponds to at least twice the number of temperature sensors.

If, for example, a temperature distribution is to be determined on a square surface of edge length 16 centimeters, wherein measuring points of the temperature distribution are to be arranged at intervals of one centimeter and parallel to the edges of the square surface so that a regular measuring grid is obtained, 256 (16×16) measuring sensors and 512 (256×2) measuring lines are to be arranged in order to determine the temperature distribution on the surface. This is associated with a high outlay and, as a result, with high costs.

Despite existing apparatuses and methods, there is accordingly a need for an improved apparatus and for an improved method for measuring a temperature distribution on a surface, wherein in particular a complexity of arrangement is to be reduced.

This technical problem is solved by an apparatus according to claim 1 and a method according to claim 7. Advantageous embodiments of the method and of the apparatus are defined by the further claims.

An apparatus for measuring a temperature distribution on a surface has a first plurality of conductors arranged parallel to one another and a second plurality of conductors arranged parallel to one another. The apparatus further has a connection conductor, which is electrically conductively connected to a voltage source, and an evaluation unit. Each conductor of the first plurality of conductors thereby crosses each conductor of the second plurality of conductors, and each conductor of the first plurality of conductors is electrically insulated from each conductor of the second plurality of conductors. A first conductor end of each of the conductors, both of the first plurality of conductors and of the second plurality of conductors, is electrically conductively connected to the connection conductor, and a second conductor end of each of the conductors, both of the first plurality of conductors and of the second plurality of conductors, is connected to a voltage measuring apparatus, which is arranged and configured to determine a voltage drop across each of the individual conductors. The evaluation unit is configured to determine a temperature distribution on the surface on the basis of the determined voltage drops across the individual conductors.

In a variant of the apparatus, each conductor of the first plurality of conductors can be arranged orthogonally to each conductor of the second plurality of conductors.

An advantage here is that the complexity of arrangement of the apparatus is reduced compared to an apparatus having individual measuring sensors and/or measuring lines. If the apparatus is arranged on a surface, for example on a straight surface or on a bent/curved/spherical surface, the surface transmits its temperature to the conductors arranged thereon. The increase in the conductor temperature results in an increase in the conductor resistance and thus in a relative increase in the voltage drop across the conductors. By means of the intersecting conductors of the first and of the second plurality of conductors, which are arranged parallel and/or orthogonally to one another, a local temperature distribution can be determined, wherein the resolution of the determined local temperature distribution increases with the number of points of intersection of the conductors on the surface in question. The temperature distribution is calculated by the evaluation unit belonging to the apparatus, which determines a temperature distribution, or a temperature profile, on the surface by means of voltage division calculations. The evaluation unit can have an electronic data processing apparatus and/or can be suitable for storing its determined temperature distributions or temperature profiles. The determined temperature distributions or temperature profiles can be stored at regular time intervals, so that it is also possible to detect time-variable or time-variant temperature distributions or temperature profiles over a predetermined time period.

In a specific embodiment, the conductors of the first plurality of conductors and/or the conductors of the second plurality of conductors are manufactured from pure nickel or a nickel alloy. The electrical resistance of pure nickel has a particularly high temperature coefficient of 0.0061/° C., so that even slight warming of the surface, or of the conductors arranged thereon, causes measurable changes of the electrical resistance of the conductors, or of the voltage drops across them. In other embodiments, different conductor materials, in particular conductor materials with high electrical (resistance) temperature coefficients, can be used for implementing the apparatus.

The connection conductor can be manufactured from a production material that is different from that of the first plurality of conductors and/or of the second plurality of conductors, for example from a copper material.

In a variant, the conductors of the first plurality of conductors and/or the conductors of the second plurality of conductors can be stranded conductors.

An advantage here is that stranded conductors can be flexibly adapted, at least to a certain extent, to an uneven surface, for example to a spherical or curved surface. Measurement of a temperature distribution on an uneven surface is thereby made possible/improved.

In one embodiment, at least some of the conductors of the first plurality of conductors can be electrically insulated from at least one conductor of the second plurality of conductors by a dielectric interlayer. Alternatively or in addition, at least some of the conductors of the first plurality of conductors can be electrically insulated from at least one conductor of the second plurality of conductors by a dielectric conductor sheathing.

An advantage here is that the insulation of the conductors from one another with the aid of a dielectric interlayer is particularly simple to implement. Alternatively or in addition, conductors already provided with a dielectric conductor sheathing can be used for implementing the apparatus. The use of conductors with an electrically insulating paint is also possible.

A distance between the conductors, arranged parallel to one another, of the first plurality of conductors can be at least substantially equal and/or a distance between the conductors, arranged parallel to one another, of the second plurality of conductors can be at least substantially equal.

An advantage of regular distances between the conductors of the first plurality of conductors and/or of the second plurality of conductors is that a regular measuring grid with regularly arranged conductor intersections is produced and thus a uniform local resolution of the temperature determination is achieved. The computational complexity of the evaluation unit, for example compared with an irregular arrangement of the conductors, can thereby be reduced.

In a further development, the first plurality of conductors and/or the second plurality of conductors and/or the connection conductor can be arranged in a dielectric carrier structure, for example a fabric or textile fabric structure, wherein the dielectric carrier structure is suitable for being arranged on a surface with a temperature distribution.

An advantage here is that the arrangement of the apparatus at or on a surface is further simplified. The conductors and/or the connection conductor can be fixed in their arrangement relative to one another by the carrier structure and/or can be integrated into the carrier structure, for example by a weaving method. The arrangement of the conductors and/or of the connection conductors on the surface can accordingly be carried out efficiently by arranging/laying the carrier structure at/on the surface.

The carrier structure can in particular be a flexible carrier structure, for example a flexible fabric or textile structure.

An advantage of a flexible carrier structure, for example a textile fabric with conductors woven in, is that it can be arranged/positioned in an improved/simplified manner on uneven, for example curved or spherical, surfaces.

The first plurality of conductors and/or the second plurality of conductors and/or the connection conductor can further be surrounded by the dielectric carrier structure, so that they are electrically insulated from one another and/or from a surface by the dielectric carrier structure.

A method for measuring a temperature distribution on a surface comprises the steps:
arranging a first plurality of mutually parallel conductors on the surface;
arranging a second plurality of mutually parallel conductors on the surface, so that each conductor of the first plurality of conductors crosses each conductor of the second plurality of conductors, and each conductor of the first plurality of conductors is electrically insulated from each conductor of the second plurality of conductors;
arranging a connection conductor which is electrically conductively connected to a voltage source;
electrically conductively connecting a first conductor end of each of the conductors, both of the first plurality of conductors and of the second plurality of conductors, to the connection conductor;
electrically conductively connecting a second conductor end of each of the conductors, both of the first plurality of conductors and of the second plurality of conductors, to a voltage measuring apparatus which is arranged and configured to determine a voltage drop across each of the individual conductors;
determining, with an evaluation unit, a temperature distribution on the surface on the basis of the determined voltage drops.

In a variant of the method, the first plurality of conductors and the second plurality of conductors can each be arranged in such a manner that each conductor of the first plurality of conductors is arranged orthogonally to each conductor of the second plurality of conductors.

In the described method, the first plurality of conductors and/or the second plurality of conductors and/or the connection conductor can be arranged in a dielectric carrier structure, for example a fabric or textile fabric structure, so that the arrangement thereof takes place by arranging the carrier structure on the surface. Furthermore, the electrically conductive connection of the conductors of the first and of the second plurality of conductors to the connection conductor and/or to the voltage measuring apparatus can be established by the arrangement of the conductors in the carrier structure.

Further features, properties, advantages and possible modifications will become clear to a person skilled in the art from the following description, in which reference is made to the accompanying drawings.

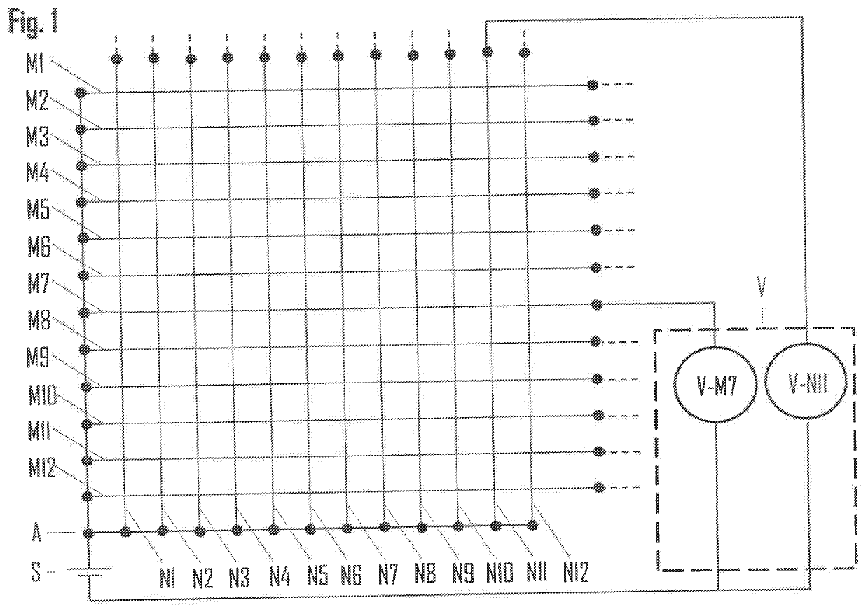

FIG. 1 shows, schematically, an example of an apparatus for measuring a temperature distribution on a surface.

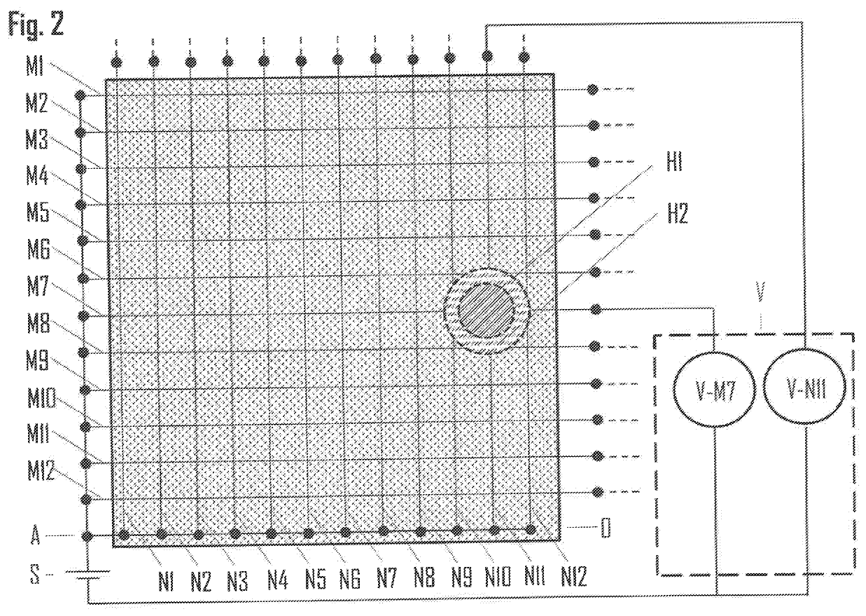

FIG. 2 shows, schematically, an example of a determination of a temperature distribution on a surface.

FIG. 1 shows an example of an apparatus for measuring a temperature distribution on a surface. More precisely, FIG. 1 shows the arrangement of a first plurality of conductors M1 . . . M12, which are arranged parallel to one another, and the arrangement of a second plurality of conductors N1 . . . N12, which are likewise arranged parallel to one another. Furthermore, each conductor of the first plurality of conductors M1 . . . M12 is arranged orthogonally to each conductor of the second plurality of conductors N1 . . . N12, so that a regular measuring grid is produced. In other embodiments of the apparatus, irregular measuring grids may also be produced. In the example shown, the distances between the conductors, both of the first plurality of conductors M1 . . . M12 and of the second plurality of conductors N1 . . . N12, are chosen to be equal, so that the measuring grid that is produced is a regular measuring grid. This simplifies the computational complexity of an evaluation unit (not shown) for determining the temperature distribution.

Both in apparatuses with a regular measuring grid, as shown in FIG. 1, and in apparatuses with an irregular measuring grid (not shown), the arrangement of the conductors, or conductor intersections, is known to the evaluation unit (not shown). For example, an electronic evaluation unit can store data which contain information about the arrangement of the conductors.

A first conductor end of each of the conductors, both of the first plurality of conductors M1 . . . M12 and of the second plurality of conductors N1 . . . N12, is electrically conductively connected to a connection conductor A. The connection conductor A is further electrically conductively connected to a voltage source S. The voltage source S is configured to provide an at least substantially constant voltage.

In the example shown, both the conductors M1 . . . M12, N1 . . . N12 and the connection conductor A are pure nickel stranded conductors with a high electrical temperature coefficient. In addition, the conductors M1 . . . M12, N1 . . . N12 are in each case produced at least substantially identically.

A second conductor end of each of the conductors, both of the first plurality of conductors M1 . . . M12 and of the second plurality of conductors N1 . . . N12, is additionally electrically conductively connected to a voltage measuring apparatus V, wherein an electric circuit to the voltage source S is closed via the voltage measuring apparatus V for each conductor. In the example shown, for reasons of clarity, only two circuits V-M7, V-N11 closed via the voltage measuring apparatus V are shown as representative examples, while the remaining electrically conductive connections, which each connect to the second conductor end of the conductors, are indicated merely schematically. Overall, the number of circuits closed via the voltage measuring apparatus V corresponds to the total number of conductors M1 . . . M12, N1 . . . N12, that is to say 24 circuits in the example shown.

The voltage measuring apparatus V is configured to determine and to store in each case a voltage drop across one of the conductors M1 . . . M12, N1 . . . N12. The voltage drop can be determined and stored at regularly repeating time intervals of, for example, one second.

FIG. 2 shows, schematically, an example of the determination of a temperature distribution on a surface using the apparatus from FIG. 1. For this purpose, the apparatus from FIG. 1 that is shown is first of all to be arranged on a surface O whose temperature distribution is to be determined. The surface shown in FIG. 2 is an even or planar surface, but the apparatus shown is equally also suitable for determining temperature distributions on curved and/or uneven surfaces.

After the apparatus has been arranged on the surface O, a temperature profile, or a temperature distribution, thereof can be determined by the evaluation unit (not shown) on the basis of the voltage drops across the individual conductors M1 . . . M12, N1 . . . N12 determined by the voltage measuring apparatus V.

If, for example, the surface O uniformly has a temperature of 20° C., that temperature is transmitted to the conductors M1 . . . M12, N1 . . . N12 after a period of time. The temperature-dependent electrical resistance of the conductors M1 . . . M12, N1 . . . N12 and the voltage drops across the conductors, which are determined by the voltage measuring apparatus V, are accordingly the same/identical for all the conductors M1 . . . M12, N1 . . . N12. The evaluation unit (not shown) consequently determines that a uniform temperature distribution is present on the surface O.

If, on the other hand, as shown in FIG. 2, a portion H1, H2 of the surface is warmed (or cooled) compared to the overall surface O, this warming (or cooling) influences the electrical resistance both of conductors M1 . . . M12 of the first plurality of conductors and of conductors N1 . . . N12 of the second plurality of conductors.

In the example shown, a region H1 of the surface is warmed to approximately 60° C. and a region H2 of the surface that surrounds the region H1 is warmed to approximately 40° C. This results, in the example shown, in a warming of conductors M6, M7 and M8 of the first plurality of conductors and in a warming of conductors N10, N11 and N12 of the second plurality of conductors. Conductors M7 and N11 are hereby warmed to a greater extent (to approximately 60° C.) than the respective adjacent conductors M6 and M8 or N10 and N12 (which are each warmed to approximately 40° C.).

The warming of each of conductors M6, M7, M8, N10, N11 and N12 increases their electrical resistance, so that the voltage drops across the conductors are relatively increased as compared with the voltage drops across the conductors that have not been warmed, whereby the voltage drops across each of the individual conductors are determined by the voltage measuring apparatus V and transmitted to the evaluation unit (not shown).

The evaluation unit (not shown) determines a temperature distribution of the conductors, or of the surface O on which the conductors are positioned. The point of the surface O that has been most warmed is located at or close to the point of intersection of the conductors with the highest determined resistance/voltage drop. In the example shown in FIG. 2, this is the warmed region H1 in the vicinity of the point of intersection of conductors M7 and N11, which are each the most warmed conductors.

The evaluation unit further determines, on the basis of the determined voltage drops across each of the individual conductors, that the surface O at or close to the points of intersection of conductors M6 and N11, of conductors M7 and N10, of conductors M7 and N12 and of conductors M8 and N11 has likewise been warmed relative to the remaining surface O, whereby the warming is, however, less than at the point of intersection of conductors M7 and N11.

The arrangement shown in FIGS. 1 and 2 of 12×12 conductors for temperature determination is merely a representative example of a large number of arrangements, which can have any desired number of conductors for temperature determination. The more conductors are arranged on a surface, the more detailed a temperature profile can be determined. In other words, the local resolution of the determined temperature profile is dependent on the number of arranged conductors.

For determining absolute measured temperature values of a surface, the measuring apparatus arranged on the surface can first be calibrated/measured under standard conditions (for example a standard temperature of 20° C.), and a temperature profile relative to this calibration/measurement can be determined.

In a further development, the conductors M1 . . . M12, N1 . . . N12 can, for example, be woven into a carrier structure and insulated from one another by the textile structure and/or by conductor insulation.

For determining an absolute local distribution of the temperature distribution of a surface, the apparatus for measuring a temperature distribution, which, for example, is woven into a textile structure, can be arranged at a predetermined corner or reference point of the surface with the aid of an auxiliary marking, in particular an optically recognizable auxiliary marking. The auxiliary marking can be arranged, for example, in an optically recognizable manner on the textile structure.

It will be appreciated that the exemplary embodiments discussed above are not conclusive and do not limit the subject-matter disclosed herein. In particular, it will be apparent to the person skilled in the art that he can combine the described features with one another as desired and/or omit various features without departing from the subject-matter disclosed herein.

1. An apparatus for measuring a temperature distribution on a surface, having:
a first plurality of conductors arranged parallel to one another;
a second plurality of conductors arranged parallel to one another;
a connection conductor, which is electrically conductively connected to a voltage source; and
an evaluation unit; wherein
each conductor of the first plurality of conductors crosses each conductor of the second plurality of conductors,
each conductor of the first plurality of conductors is electrically insulated from each conductor of the second plurality of conductors,
a first conductor end of each of the conductors, both of the first plurality of conductors and of the second plurality of conductors, is electrically conductively connected to the connection conductor,
a second conductor end of each of the conductors, both of the first plurality of conductors and of the second plurality of conductors, is connected to a voltage measuring apparatus, which is arranged and configured to determine a voltage drop across each of the individual conductors by means of voltage division calculations, and
the evaluation unit is configured to determine a temperature distribution on the basis of the determined voltage drops across the individual conductors.

2. The apparatus as claimed in claim 1, wherein
each conductor of the first plurality of conductors is arranged orthogonally to each conductor of the second plurality of conductors.

3. The apparatus as claimed in claim 1, wherein
the conductors of the first plurality of conductors and/or the conductors of the second plurality of conductors are manufactured from nickel or a nickel alloy.

4. The apparatus as claimed in claim 1, wherein
the conductors of the first plurality of conductors and/or the conductors of the second plurality of conductors are stranded conductors.

5. The apparatus as claimed in claim 1, wherein
conductors of the first plurality of conductors are electrically insulated from at least one conductor of the second plurality of conductors by a dielectric interlayer, and/or
conductors of the first plurality of conductors are electrically insulated from at least one conductor of the second plurality of conductors by a dielectric conductor sheathing.

6. The apparatus as claimed in claim 1, wherein
a distance between the conductors, arranged parallel to one another, of the first plurality of conductors is at least substantially equal, and/or
a distance between the conductors, arranged parallel to one another, of the second plurality of conductors is at least substantially equal.

7. The apparatus as claimed in claim 1, wherein
the first plurality of conductors and/or the second plurality of conductors and/or the connection conductor are arranged in a dielectric carrier structure, for example a fabric or textile fabric structure, and wherein
the dielectric carrier structure is suitable for being arranged on a surface with a temperature distribution.

8. A method for measuring a temperature distribution on a surface comprises the steps:
arranging a first plurality of mutually parallel conductors on the surface;
arranging a second plurality of mutually parallel conductors on the surface, so that each conductor of the first plurality of conductors crosses each conductor of the second plurality of conductors, and each conductor of the first plurality of conductors is electrically insulated from each conductor of the second plurality of conductors;
arranging a connection conductor which is electrically conductively connected to a voltage source;
electrically conductively connecting a first conductor end of each of the conductors, both of the first plurality of conductors and of the second plurality of conductors, to the connection conductor;
electrically conductively connecting a second conductor end of each of the conductors, both of the first plurality of conductors and of the second plurality of conductors, to a voltage measuring apparatus which is arranged and configured to determine a voltage drop across each of the individual conductors by means of voltage division calculations;
determining, with an evaluation unit, a temperature distribution on the surface on the basis of previously determined voltage drops.

9. The method as claimed in claim 8, wherein
the first plurality of conductors and the second plurality of conductors are each arranged in such a manner that each conductor of the first plurality of conductors is arranged orthogonally to each conductor of the second plurality of conductors.

10. The method as claimed in claim 8, wherein
the first plurality of conductors and/or the second plurality of conductors and/or the connection conductor are arranged in a dielectric carrier structure, for example a fabric or textile fabric structure, so that the arrangement thereof on the surface takes place by arranging the carrier structure on the surface, and/or
the electrically conductive connection of the conductors of the first and of the second plurality of conductors to the connection conductor and/or to the voltage measuring apparatus is established by the arrangement of the conductors in the carrier structure.
